(19) United States
(12) Patent Application Publication
(10) Pub. No.: US 2024/0177216 A1
(43) Pub. Date: May 30, 2024

(54) DIGITAL AVATAR RECOMMENDATION METHOD AND RECOMMENDATION SYSTEM

(71) Applicants: Alipay (Hangzhou) Information Technology Co., Ltd., Hangzhou (CN); ALIBABA GROUP HOLDING LIMITED, George Town (KY)

(72) Inventors: Junwu XIONG, Hangzhou (CN); Xiaoyu TAN, Hangzhou (CN); Hairui XU, Hangzhou (CN); James ZHANG, Hangzhou (CN); Wei CHU, Hangzhou (CN); Yunzhou SHI, George Town (KY); Zhongzhou ZHAO, George Town (KY); Wei ZHOU, George Town (KY); Xiaolong LI, George Town (KY)

(21) Appl. No.: 18/516,730

(22) Filed: Nov. 21, 2023

(30) Foreign Application Priority Data
Nov. 25, 2022 (CN) 202211489297.3

(51) Int. Cl. G06Q 30/0601; G06Q 30/0217; H04N 21/2187; H04N 21/25; H04N 21/81

(52) U.S. Cl. CPC G06Q 30/0631; G06Q 30/0218; H04N 21/2187; H04N 21/251; H04N 21/812

(57) ABSTRACT

Implementations of the present specification provide a digital avatar recommendation method and recommendation system. The digital avatar recommendation system includes a computer-simulated digital avatar, and the corresponding recommendation method includes: obtaining current state data, where the state data includes user information of a target user, scenario information of a current scenario, and history information of an interaction between the target user and the digital avatar; mapping, by an agent in the digital avatar, the state data to a target action in a candidate action set based on a current policy obtained through reinforcement learning, where a candidate action in the candidate action set corresponds to a to-be-recommended content category, and the target action corresponds to a target content category; and performing, by the digital avatar, target interaction with the target user, where the target interaction is used to recommend the target content category. As such, individualized recommendation is provided for the target user by using the digital avatar.

### TECHNICAL FIELD

One or more implementations of the present specification relate to the field of machine learning, and in particular, to a method and system for performing recommendation by using a digital avatar.

### BACKGROUND

On the Internet environment, there are various recommendation scenarios, such as shopping recommendation, video recommendation generated during short video watching, and friend recommendation in social networks. Therefore, a recommendation system needs to be used to provide individualized recommendation for a user, to display content that is more likely to be of interest to the user, including commodities, articles, and other objects, and better provide targeted services for the user.

Generally, the recommendation system typically uses the following working mode: First, a batch of candidate content items that are possibly of interest to the user are prepared, and then the candidate content items are ranked based on a feature of the user, and several content items that rank in the front are recalled. Finally, the several recalled content items are displayed on a page. In the above mode, due to a limitation of a display location on the display page, only a small quantity of content items can be displayed, and a large quantity of content items have no chance to be displayed. In another aspect, recommendation can only be passively displayed and pushed to the user, and generally, the user cannot perform continuous interaction, which is not conducive to understand a preference and a requirement of the user.

### SUMMARY

One or more implementations of the present specification describe a digital avatar recommendation method and system, and a recommendation decision can be made by using a digital avatar through a reinforcement learning policy, which results in a better recommendation effect and improved user experience.

According to an aspect, a recommendation method is provided and is performed by a digital avatar recommendation system, the digital avatar recommendation system includes a computer-simulated digital avatar, and the method includes: obtaining current state data, where the state data includes user information of a target user, scenario information of a current scenario, and history information of an interaction between the target user and the digital avatar; mapping, by an agent in the digital avatar, the state data to a target action in a candidate action set based on a current policy obtained through reinforcement learning, where a candidate action in the candidate action set corresponds to a to-be-recommended content category, and the target action corresponds to a target content category; and performing, by the digital avatar, target interaction with the target user, where the target interaction is used to recommend the target content category.

According to an implementation, the current scenario is a live streaming scenario, the digital avatar is a live streamer in the live streaming scenario, and the target user is a user entering the live streaming scenario.

Further, in an implementation, the scenario information includes a theme of the live streaming, category information of a store to which the live streaming belongs, and an element in the live streaming to which the target user has interacted.

In an implementation, the scenario is a metaverse, and the digital avatar is a system role in the metaverse.

In an implementation, the method further includes: obtaining a target feedback of the target user for the target interaction; and determining, based on the target feedback, a reward score corresponding to the target action, where the reward score is used to update the current policy.

Further, the reward score corresponding to the target action can be determined in the following manner: determining that the reward score is a first value if the target feedback indicates that the target user accepts the target content category; or determining that the reward score is a second value if the target feedback indicates that the target user does not accept the target content category, where the second value is less than the first value.

In an implementation, the mapping the state data to the target action in the candidate action set includes: determining, based on the state data, long-term cumulative reward Q values corresponding to candidate actions in the candidate action set, to obtain Q values; and determining the target action based on the Q values.

According to an implementation, the state data is obtained by fusing source data of a plurality of modes, and the source data of the plurality of modes includes at least two of the following: text source data, image source data, audio source data, or video source data.

In an implementation, the user information includes relationship information obtained based on a user relationship network graph, and the state data includes graph data of the relationship network graph.

In an implementation, the state data further includes graph data of a knowledge graph, and an entity in the knowledge graph corresponds to the to-be-recommended content category.

According to an implementation, the digital avatar has configuration parameters defining character features of the digital avatar, and the state data further includes the configuration parameters.

According to an aspect, a digital avatar recommendation system is provided, including a state acquisition module and a computer-simulated digital avatar, where an agent is embedded into the digital avatar.

The state acquisition module is configured to obtain current state data, where the state data includes user information of a target user, scenario information of a current scenario, and history information of an interaction between the target user and the digital avatar.

The agent is configured to map the state data to a target action in a candidate action set based on a current policy obtained through reinforcement learning, where a candidate action in the candidate action set corresponds to a to-be-recommended content category, and the target action corresponds to a target content category.

The digital avatar is configured to perform target interaction with the target user, where the target interaction is used to recommend the target content category.

In an implementation, the digital avatar recommendation system further includes an updating module, and the updating module is configured to: obtain a target feedback of the target user for the target interaction; determine, based on the target feedback, a reward score corresponding to the target action; and update the current policy based on the reward score.

According to an aspect, a computer-readable storage medium is provided. The computer-readable storage medium stores a computer program, and when the computer program is executed on a computer, the computer is enabled to perform the method according to the first aspect.

According to an aspect, a computing device is provided, including a memory and a processor. The memory stores executable code, and the processor implements the method according to the first aspect when executing the executable code.

In the implementations of the present specification, a new framework in which a digital avatar performs recommendation through reinforcement learning is proposed. In the framework, the digital avatar is applied to a recommendation scenario to form a digital avatar recommendation system, so as to provide a better recommendation service by using a feature of the digital avatar. In addition, in the digital avatar recommendation system, an agent obtained through reinforcement learning is embedded or introduced into an analog program of the digital avatar to form a digital avatar recommendation engine based on reinforcement learning. Based on repeated interaction between the digital avatar and a user, the recommendation engine can better understand a requirement and a preference of the user, and more accurately perform recommendation.

### BRIEF DESCRIPTION OF DRAWINGS

To describe the technical solutions in the implementations of the present specification more clearly, the following is a brief introduction of the accompanying drawings for illustrating such implementations. Clearly, the accompanying drawings described below are merely some implementations of the present specification, and a person of ordinary skill in the art can derive other drawings from such accompanying drawings without making innovative efforts.

FIG. 1 is a schematic diagram illustrating a typical reinforcement learning system;

FIG. 2 is a schematic diagram illustrating a digital avatar recommendation system according to an implementation;

FIG. 3 is an execution flowchart illustrating a recommendation method according to an implementation; and

FIG. 4 is a schematic diagram illustrating a structure of a digital avatar recommendation system according to an implementation.

### DESCRIPTION OF EMBODIMENTS

The following describes the solutions provided in the present specification with reference to the accompanying drawings.

In the implementations of the present specification, a digital avatar is used for recommendation to form a digital avatar recommendation system.

A digital human, also referred to as a digital avatar, an avatar or a virtual avatar, is a virtual agent simulated by a computer. The digital avatar may have a three-dimensional digital body, can communicate with a real human user by using a natural language, understand content of a statement, and infer a meaning, and can also have character features such as a facial expression, emotion, and personality feature of a real person. In a given virtual scenario, the digital avatar can further perform various body actions.

The digital avatar is formed based on a large number of machine learning models and a large amount of training data, including a conversation generation model based on natural language processing NLP, a reasoning model, an action generation model, etc. In addition, a computation module, such as an animation construction module, which is configured to render and present a digital avatar form is further used. Currently, many Internet companies provide various platforms and tools, and these platforms and tools can be used to generate the digital avatar or some modules of the digital avatar. Therefore, the digital avatar can be widely applied to various digital scenarios.

For example, in a rapidly growing metaverse field, the digital avatar can understand user interaction content and quickly respond to a user behavior by using an advantage of an artificial intelligence (AI) algorithm. Advantages of the digital avatar lie not only in that a requirement of a user can be satisfied. In addition, because the digital avatar can have character features such as a facial expression, emotion, and personality feature that are similar to those of a real person, a response can be made in a very “humanized” friendly manner to further improve user experience.

In the implementations of the present specification, the digital avatar is applied to a recommendation system to form a digital avatar recommendation system, which provides a better recommendation service by using the features of the digital avatar. For example, the digital avatar can repeatedly interact with a user, to actively capture attention of the user, better understand a requirement and a preference of the user by using interaction content, and more accurately perform recommendation.

Further, to better make a recommendation decision based on an interaction between the digital avatar and the user, in the implementations of the present specification, a recommendation policy is formed through reinforcement learning.

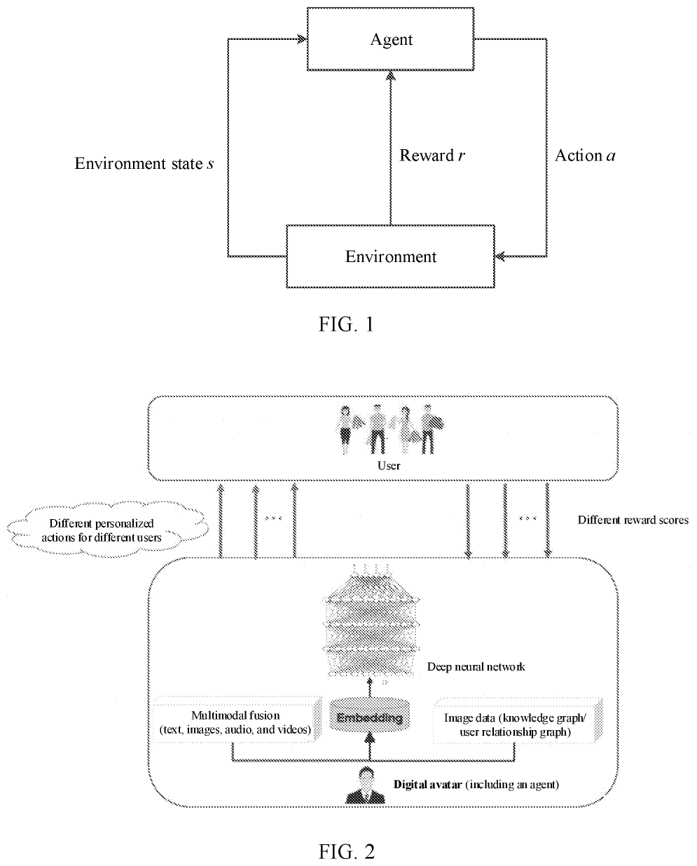

FIG. 1 is a schematic diagram illustrating an example reinforcement learning system. As shown in FIG. 1, generally, the reinforcement learning system includes an agent (Agent) and an execution environment. The agent constantly performs learning and optimizes a policy of the agent by interacting with and giving a feedback to the execution environment. For example, the agent observes and obtains a state (state) of the execution environment, and determines, based on a policy, a behavior or an action (action) to be taken in the current state of the execution environment. When the behavior is performed on the execution environment, the state of the execution environment is changed, and a feedback is generated to the agent. The feedback is also referred to as a reward (reward) score. The agent determines, based on the obtained reward score, whether the previous behavior is correct and whether the policy needs to be adjusted, so as to update the policy of the agent. The agent repeatedly and constantly observes the state, determines the behavior, and receives the feedback, so that the agent can constantly update the policy. An ultimate goal is to learn a policy to maximize an obtained long-term cumulative reward score.

The above process can be modeled as a Markov decision process (MDP). The MDP process can be described by using a tuple (S, A, p, r, γ), where S represents state space that can be observed by the agent, and A represents action space that can be used by the agent, and includes all possible actions. It is assumed that in a t^{th} round of interaction, an environment state is sₜ, and an action taken is aₜ. In this case, the environment state is migrated to a new state sₜ₊₁ by using a migration probability function p, e.g., sₜ₊₁˜p(. |sₜ, aₜ). In addition, the migration generates a reward score rₜ=r(sₜ, aₜ), where γ is a discount coefficient of the reward score.

In the MDP process, the agent performs learning by repeatedly and constantly observing the state, determining the behavior, and receiving the feedback. The goal of learning is to find a policy It that can improve a given performance evaluation function J(π). For example, the performance evaluation function in the given policy can be defined as a discount cumulative reward of an infinite number of steps in the policy, for example:

$$J ( π ) = {E}_{τ \sim π} [ {\sum }_{t = 0}^{∞} {γ}^{t} r ( {s}_{t} , {a}_{t} , {s}_{t + 1} ) ] \qquad ( 1 )$$

where r(sₜ, aₜ, sₜ₊₁)indicates that in the t^{th} step, the action aₜ is used in the state sₜ, so that the state changes to a reward score obtained in the state sₜ₊₁; and γ is the discount coefficient.

In a value-based policy update solution, the goal of agent learning is to achieve an improved value function. The value function is a discount cumulative reward function to be achieved by executing the policy π. In an implementation, a state-action value function, e.g., a q function, can be defined to represent a long-term cumulative reward:

q_{π}(s, a)=E_{τ˜π}[r(τ)|s₀=s, a₀=a] (2)

The state-action value function represents a cumulative reward brought by using the policy π after an action a₀ is performed starting from a state s₀. A cumulative reward in the t^{th} step can be obtained based on the state-action value function, which is referred to as a Q value.

The policy π adopted by the agent can be considered as a function for mapping from the state s to the action a, and a parameter in the function can be represented as θ. Therefore, the process of reinforcement learning is a process of finding out reward scores obtained by performing various actions in various states through continuous “trial and error”, and continuously adjusting and updating the parameter θ based on feedbacks of the reward scores, so as to obtain a trained policy. A trained policy finally obtained can be used to perform an appropriate action a based on a current state s. This action can make the obtained long-term cumulative reward score as large as possible.

In view of the above features of reinforcement learning, the agent obtained through reinforcement learning can be embedded or introduced into an analog program of the digital avatar to form a digital avatar recommendation engine based on reinforcement learning. Based on repeated interaction between the digital avatar and a user, the recommendation engine can better understand a requirement and a preference of the user, and more accurately perform recommendation.

FIG. 2 is a schematic diagram illustrating a digital avatar recommendation system according to an implementation. As shown in FIG. 2, a digital avatar can perform a plurality of rounds of interaction with a plurality of users to form a corresponding interaction session. According to an implementation, an agent obtained through reinforcement learning is introduced into the digital avatar. Correspondingly, different states of an execution environment can be formed based on different user information and interaction sessions, and in some implementations, an action space A is formed based on a to-be-recommended content. For different users, the agent determines, based on different environment states, recommendation actions to be performed next, and the digital avatar interacts with the users based on the recommendation actions. As such, the digital avatar implements active and targeted content recommendation by interacting with the user.

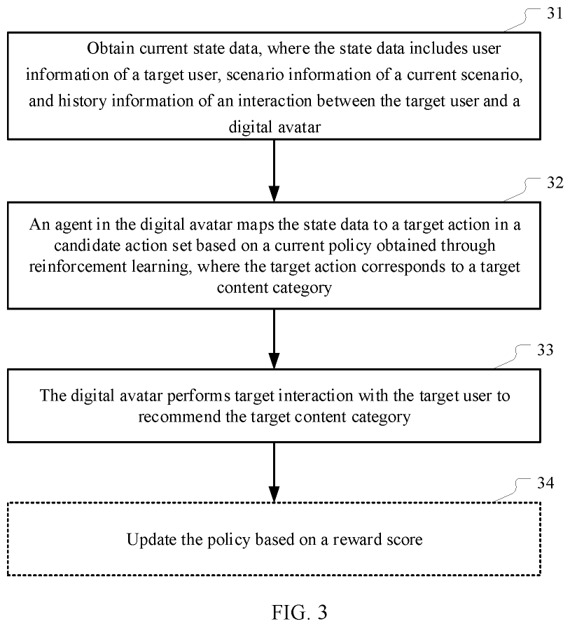

The technical concept and framework of the solutions in the implementations of the present specification are described above. An example recommendation execution process of the digital avatar recommendation system is described below by combining FIG. 2 and FIG. 3.

FIG. 3 is an execution flowchart illustrating a recommendation method according to an implementation. It should be noted that the method is performed by the digital avatar recommendation system. The digital avatar recommendation system includes a computer-simulated digital avatar. An analog program of the digital avatar includes an agent implemented through reinforcement learning. In context, this is sometimes simply stated as: a digital avatar has an agent (obtained through reinforcement learning). It should be understood that the digital avatar recommendation system can be implemented by any apparatus, device, platform, device cluster having a computing and processing capabilities.

As shown in FIG. 3, the recommendation method includes the following steps: Step 31: The recommendation system obtains current state data, where the state data includes user information of a target user, scenario information of a current scenario, and history information of an interaction between the target user and the digital avatar. Step 32: The agent in the digital avatar maps the state data to a target action in a candidate action set based on a current policy obtained through reinforcement learning, where a candidate action in the candidate action set corresponds to a to-be-recommended content category, and the target action corresponds to a target content category. Step 33: The digital avatar performs target interaction with the target user, where the target interaction is used to recommend the target content category. The following describes specific example execution of the above steps.

First, in step 31, the recommendation system obtains the current state data for the target user, that is, a current state s of an execution environment. The state data s can include the scenario information of the current scenario, e.g., in which the target user is located, the user information of the target user, and a history of an interaction between the target user and the digital avatar.

In an implementation, the digital avatar and the target user are located in a scenario in a metaverse, for example, a store, a cinema, or a social occasion, where the digital avatar is a system role in the metaverse, and the target user can be a real human user or a player role controlled by the real human user. In this case, the scenario information can include information about the scenario in the metaverse, for example, a store location and a category, or a cinema location and film programming. In addition, the scenario information can further include information about an association relationship between the scenario and another scenario in the metaverse, etc. There are possibly a plurality of digital avatars in the metaverse scenario. In this case, the digital avatar described in the present specification can be any digital avatar suitable for recommendation in the metaverse.

In an implementation, the current scenario is a live streaming scenario, where the digital avatar is a live streamer in the live streaming scenario, and the target user is a user entering the live streaming scenario. In this case, the scenario information can include information related to the live streaming, such as an ID of the live streaming, a theme of the live streaming, and a layout of the live streaming. In a case of a live streaming dedicated to introduce/purchase commodities opened by a store, e.g., , a live streaming for sending commodities, information about the live streaming can include category information of the store to which the live streaming belongs, a commodity layout displayed in the live streaming, an element in the live streaming with which the target user has interacted (for example, clicked or browsed), etc.

The digital avatars and the target users in the above various scenarios can be in a one-to-one relationship, or can be in a one-to-many relationship. In a one-to-one scenario, one digital avatar interacts with only one user at a same time. In a one-to-many scenario, one digital avatar can interact with a plurality of users at a same time. For example, in a typical live streaming scenario, a digital avatar in live streaming can interact with a plurality of users entering the live streaming, and the target user can be any one of the plurality of users. However, in a case of targeted recommendation in the present specification, the plurality of users entering the live streaming can experience different recommendation interactions.

To provide individualized recommendation for the target user, the state data s further includes the user information of the target user, which reflects a feature of the target user. The user information can include basic attribute features of the target user, such as a user identifier, a nickname, a user profile picture, registration duration, an education level, and an occupation, and can further include a user profile feature such as a group label to which the target user belongs. In addition, the user information can further include information about the rights and interests of the target user, for example, categories of discount cards, discount rates, and coupons that are owned by the target user.

In an implementation, the user information can further include a user relationship network graph, or relationship information that is related to the target user and that is obtained based on the user relationship network graph, e.g., some graph information in the user relationship network graph. The user relationship network graph can be in a form of a user social relationship graph, a user transaction relationship graph, etc. In such a user relationship network graph, a node represents a user, and an edge represents an association relationship between users, such as a social relationship or a transaction relationship. A more comprehensive embedding representation of the target user can be obtained based on adjacency information of the target user by using the user relationship network graph.

In addition to the static user information, the state data s further includes the history information of the interaction between the target user and the digital avatar. In an example, the interaction history can include a conversation record between the target user and the digital avatar, and the conversation record can be in a text form, a voice form, etc. The interaction history can further include historical recommendation information of the target user, for example, a recommended content list of content that the digital avatar has recommended to the target user, and an accepted content list of content that has been recommended by the digital avatar and accepted by the target user. Based on different recommended content, a behavior of accepting the recommended content can be: clicking the recommended content; browsing the recommended content for more than a threshold duration; when the recommended content is information about rights and interests (for example, a red envelope or a coupon), obtaining the rights and interests in the recommended content; or when the recommended content is a commodity, buying the commodity, etc. In some implementations, the historical recommendation information can further include a rejected content list of content that the target user has explicitly rejected, a content of interest list of recommended content that the target user is interested in (for example, adding the recommended content to favorites, or setting the recommended content to “see later”), etc.

To represent the current environment state more comprehensively, in an implementation, knowledge graph information related to the to-be-recommended content is further included in the state data. For example, an entity in a knowledge graph can correspond to a to-be-recommended content category, and a relationship between entities corresponds to a relationship between to-be-recommended content. For example, the to-be-recommended content is clothing commodities. Entities can correspond to categories such as hats, scarves, upper clothes, trousers, dresses, shoes. A relationship between these entities can be a relationship between these categories, for example, a matching relationship, an associated purchase, or a shared discount.

According to an example implementation, the digital avatar has configuration parameters defining character features of the digital avatar. These configuration parameters can define individualized content such as a personality feature, an action feature, and a language style of the digital avatar. In some systems, all digital avatars share the configuration parameters. In some other systems, different digital people have different configuration parameters. In an implementation, the configuration parameters of the current digital avatar are also included in the state data s to better describe a current environment state of the recommendation system.

It should be appreciated that the state data includes a plurality of aspects of environment state information. As shown in FIG. 2, the plurality of aspects of information are often located in different modes or different forms. Therefore, the state data can be obtained by fusing source data of a plurality of modes, and the source data of the plurality of modes can include text source data, image source data, audio source data, video source data, etc. For example, the text source data can include a chat text record of the target user, the image source data can include a profile picture of the target user and a layout picture in a live streaming, the audio source data can include a voice of the target user, or the video source data can include a digital recorded screen of a process of interaction between the target user and the digital avatar. In some implementations, the state data can further include graph data. The graph data includes graph data of the user relationship network graph and/or graph data of the knowledge graph related to the recommended content. Through the above multimodal fusion, a more rich and comprehensive state representation can be obtained.

It should be noted that although instances of information items included in the state data are described above by using examples, the state data does not necessarily include content in all the above examples. In some implementations, the information items enumerated above can be selected or amplified based on a system requirement, so as to flexibly form the state data.

Next, in step 32, the current state data s is input to the agent in the digital avatar. The agent maps the state data to the target action a in the candidate action set based on the current policy x obtained through reinforcement learning, e.g., determines a recommendation action a for the target user from the candidate action set A. It should be understood that the candidate action set A is used to define action space formed by all possible recommendation actions. In an implementation, candidate actions in the candidate action set A corresponds to to-be-recommended content categories, e.g., the content categories form candidate action space.

In an implementation, a content category corresponds to a to-be-recommended content item, such as a commodity, an article, a video, etc. In this case, a dimension of the action space is equal to a number of content items. For example, if a number of different commodities to be recommended/sold in a live streaming of a store is N, corresponding N candidate actions form the action space.

To reduce complexity, in an implementation, a content category corresponds to a type of content item. For example, to-be-recommended content items are classified in advance, and a content category is formed based on a type of content item obtained through classification. In this case, the dimension of the action space is equal to a number of content item categories. For example, if clothing commodities are recommended/sold in a live streaming of a store, and are divided into six categories in advance: hats, scarves, upper clothes, trousers, dresses, and shoes, corresponding six candidate actions form the action space.

It should be understood that a division granularity of the action space can be set based on factors such as differentiation of to-be-recommended content, required precision, and a computing capability.

As described herein, the policy x obtained through reinforcement learning can be considered as a function for mapping from environment state space to the action space. Therefore, the agent in the digital avatar can map the current state data s to the target action a in the candidate action set based on the current policy x. In an implementation, the agent can be implemented by a neural network.

According to an implementation, the agent can determine the target action as follows. First, long-term cumulative reward Q values corresponding to candidate actions in the candidate action set are determined based the state data s. As defined in the above equation (2), a Q value corresponding to an action i represents a cumulative reward in a t^{th} step brought by using the policy π after the action i is performed starting from a current state s. Then, the target action a is determined based on the Q values corresponding to the candidate actions.

In an example, an action corresponding to a maximum value in the Q values can be determined as the target action based on a greedy algorithm. In an example, the target action is selected from actions corresponding to non-maximum values by using a probability ε, and an action corresponding to a maximum Q value is selected as the target action by using a probability (1<ε).

It can be understood that the determined target action corresponds to the target content category. Based on the division granularity of the action space, the target content category can be a target content item or a type of content item.

In step 33, the digital avatar performs target interaction with the target user, and the target interaction is used to recommend the target content category.

For example, the digital avatar can perform the target interaction with the target user based on a feature of a scenario in which the digital avatar is located, so as to recommend the target content category corresponding to the target action. For example, a manner of the target interaction can be: sending recommended text to the target user, making a conversation with the target user in a text form or a voice form, displaying the target content category to the target user, presenting the target content category at a site in a live streaming, and introducing the target content category.

In an example, the digital avatar has configuration parameters reflecting character features of the digital avatar. In this case, the digital avatar can interact with the target user in a manner specific to the digital avatar based on the configuration parameters. For example, the digital avatar makes a voice conversation by using a specific tone and a voice intonation, adds an expression symbol commonly used by the digital avatar to conversation text, and displays the target content category by using a specific body action.

As such, the digital avatar can provide individualized and targeted recommendation for the target user in an interactive manner based on a feature of the target user.

It can be understood that when the target action is performed on a system environment, an environment state is changed. For example, a recommended list of a user is updated to be used for next round of interactive recommendation.

Further, depending on a feedback of the target user for the target action, for example, accepting the recommendation, refusing the recommendation, partially accepting the recommendation, adding the recommendation to favorites, the target action can correspond to an instant reward score r. Therefore, in an implementation, after the digital avatar performs a target recommendation action for the target user, the method further includes step 34 of updating the policy based on the reward score. For example, in this step, the system obtains a target feedback of the target user for the target interaction; determines, based on the target feedback, a reward score corresponding to the target action; and updates the current policy based on the reward score.

In an implementation, it is determined that the reward score is a first value if the target feedback indicates that the target user accepts the target content category; or it is determined that the reward score is a second value if the target feedback indicates that the target user does not accept the target content category, where the second value is less than the first value. For example, if the target user accepts a current recommendation, for example, clicks/purchases a recommended commodity and watches a recommended video, the reward score is set to 1 (the first value); or if the user does not accept the current recommendation, the reward score is set to 0 (the second value). In a case of partial acceptance (for example, a plurality of commodities of one category are recommended at a time, and some of these commodities are accepted by the user, or the user adds the recommended content to a shopping cart/adds the recommended content to favorites, but does not purchase/read the recommended content), more reward values can be further set based on an acceptance degree. Certainly, a higher acceptance degree of the target user for a recommendation action indicates a larger reward score.

As such, the obtained reward score can be used to update a policy. In an implementation, updating the policy can be updating the current policy in the agent based on the currently obtained reward score r. It can be understood that, although the policy can also be updated once based on a feedback of a single recommendation action, e.g., a policy parameter is updated once for a plurality of feedback actions. For example, the current state data s, the target action a, the obtained reward score r, and a new state s′ migrated to can form a piece of training data (s, a, r, s′), and the training data is added to a training data set. When an amount of training data is accumulated, the policy π is updated once based on the training data that includes the current reward score r. The policy can be updated by using various reinforcement learning algorithms, which are not limited herein.

In the above process, the agent obtained through reinforcement learning is embedded into the digital avatar, and the agent determines the recommendation action based on the feature of the target user, so that the digital avatar provides targeted and individualized recommendation for the target user in an interactive manner, to form a new digital avatar recommendation system.

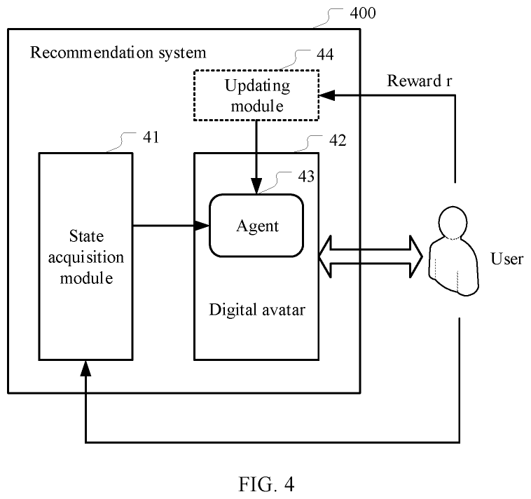

According to an implementation of an aspect, a digital avatar recommendation system is provided. The system can be deployed in any device, platform, or a device cluster having data storage, computing, and processing capabilities. FIG. 4 is a schematic diagram illustrating a structure of a digital avatar recommendation system according to an implementation. As shown in FIG. 4, the recommendation system 400 includes a state acquisition module 41 and a computer-simulated digital avatar 42. An agent 43 is embedded into the digital avatar.

The state acquisition module 41 is configured to obtain current state data, where the state data includes user information of a target user, scenario information of a current scenario, and history information of an interaction between the target user and the digital avatar.

The agent →is configured to map the state data to a target action in a candidate action set based on a current policy obtained through reinforcement learning, where a candidate action in the candidate action set corresponds to a to-be-recommended content category, and the target action corresponds to a target content category.

The digital avatar 42 is configured to perform target interaction with the target user, where the target interaction is used to recommend the target content category.

According to an implementation, the digital avatar recommendation system 400 further includes an updating module 44. The updating module is configured to: obtain a target feedback of the target user for the target interaction; determine, based on the target feedback, a reward score corresponding to the target action; and update the current policy based on the reward score.

For implementations of the modules and components in the recommendation system, references can be made to the above descriptions provided with reference to FIG. 3. Through the above recommendation system, targeted and individualized recommendation can be better provided for a user in an interactive manner.

According to an implementation of another aspect, a computer-readable storage medium is further provided. The computer-readable storage medium stores a computer program. When the computer program is executed in a computer, the computer is enabled to perform the method described with reference to FIG. 2 or FIG. 4.

According to an implementation of still another aspect, a computing device is further provided and includes a memory and a processor. The memory stores executable code, and when executing the executable code, the processor implements the method described with reference to FIG. 2 or FIG. 4.

A person skilled in the art should be aware that, in the above one or more examples, functions described in the present specification can be implemented by hardware, software, firmware, or any combination thereof. When software is used for implementation, these functions can be stored in a computer-readable medium or transmitted as one or more instructions or code on the computer-readable medium.

The technical characteristics, technical solutions, and beneficial effects of the present specification are further described in detail in the above illustrative implementations. It should be understood that the above descriptions are merely example implementations of the present specification, but are not intended to limit the protection scope of the present specification. Any modification, equivalent replacement, or improvement made based on the technical solutions of the present specification shall fall within the protection scope of the present specification.

Claims what is claimed is:

1. A recommendation method, comprising:
obtaining current state data, by a digital avatar recommendation system, the state data including user information of a target user, scenario information of a current scenario, and history information of an interaction between the target user and the digital avatar, the digital avatar recommendation system including a computer-simulated digital avatar and an agent in the digital avatar;
mapping, by the agent in the digital avatar, the current state data to a target action in a candidate action set based on a current policy obtained through reinforcement learning, a candidate action in the candidate action set corresponding to a to-be-recommended content category, and the target action corresponding to a target content category; and
performing, by the digital avatar, a target interaction with the target user, wherein the target interaction is used to recommend the target content category.

2. The method according to claim 1, wherein the current scenario is a live streaming scenario, the digital avatar is a live streamer in the live streaming scenario, and the target user is a user entering the live streaming scenario.

3. The method according to claim 2, wherein the scenario information includes one or more of a theme of the live streaming, category information of a store to which the live streaming belongs, or an element in the live streaming with which the target user has interacted.

4. The method according to claim 1, wherein the current scenario is a metaverse, and the digital avatar is a system role in the metaverse.

5. The method according to claim 1, further comprising:
obtaining a target feedback of the target user for the target interaction;
determining, based on the target feedback, a reward score corresponding to the target action; and
updating the current policy based on the reward score.

6. The method according to claim 5, wherein the determining the reward score corresponding to the target action including:
determining that the reward score is a first value in response to the target feedback indicates that the target user accepts the target content category; and
determining that the reward score is a second value in response to the target feedback indicates that the target user does not accept the target content category, where the second value is less than the first value.

7. The method according to claim 1, wherein the mapping the state data to the target action in the candidate action set includes:
determining, based on the state data, long-term cumulative reward Q values corresponding to candidate actions in the candidate action set; and
determining the target action based on the long-term cumulative reward Q values.

8. The method according to claim 1, wherein the obtaining the current state data includes fusing source data of a plurality of modes, and the source data of the plurality of modes includes at least two of: text source data, image source data, audio source data, or video source data.

9. The method according to claim 1, wherein the user information includes relationship information obtained based on a user relationship network graph, and the current state data includes graph data of the relationship network graph.

10. The method according to claim 1, wherein the current state data further includes graph data of a knowledge graph, and an entity in the knowledge graph corresponds to the to-be-recommended content category.

11. The method according to claim 1, wherein the digital avatar has configuration parameters defining character features of the digital avatar, and the state data further includes the configuration parameters.

12. A digital avatar recommendation system, comprising one or more storage devices and one or more processors, the one or more storage devices, individually or collectively, having executable instructions stored thereon, the executable instructions when executed by the one or more processors, enabling the one or more processors to, individually or collectively, implement a state acquisition module, a computer-simulated digital avatar, an agent embedded in the digital avatar, wherein:
the state acquisition module is configured to obtain current state data, the state data including user information of a target user, scenario information of a current scenario, and history information of an interaction between the target user and the digital avatar;
the agent in the digital avatar is configured to map the current state data to a target action in a candidate action set based on a current policy obtained through reinforcement learning, a candidate action in the candidate action set corresponding to a to-be-recommended content category, and the target action corresponding to a target content category; and
the digital avatar is configured to perform a target interaction with the target user, wherein the target interaction is used to recommend the target content category.

13. The digital avatar recommendation system according to claim 12, wherein the executable instructions further enable the one or more processors to, individually or collectively, implement an updating module configured to:
obtain a target feedback of the target user for the target interaction;
determine, based on the target feedback, a reward score corresponding to the target action; and
update the current policy based on the reward score.

14. The digital avatar recommendation system according to claim 13, wherein the determining the reward score corresponding to the target action including:
determining that the reward score is a first value in response to the target feedback indicates that the target user accepts the target content category; and
determining that the reward score is a second value in response to the target feedback indicates that the target user does not accept the target content category, where the second value is less than the first value.

15. The digital avatar recommendation system according to claim 12, wherein the mapping the state data to the target action in the candidate action set includes:
determining, based on the state data, long-term cumulative reward Q values corresponding to candidate actions in the candidate action set; and
determining the target action based on the long-term cumulative reward Q values.

16. The digital avatar recommendation system according to claim 12, wherein the obtaining the current state data includes fusing source data of a plurality of modes, and the source data of the plurality of modes includes at least two of: text source data, image source data, audio source data, or video source data.

17. The digital avatar recommendation system according to claim 12, wherein the user information includes relationship information obtained based on a user relationship network graph, and the current state data includes graph data of the relationship network graph.

18. The digital avatar recommendation system according to claim 12, wherein the current state data further includes graph data of a knowledge graph, and an entity in the knowledge graph corresponds to the to-be-recommended content category.

19. The digital avatar recommendation system according to claim 12, wherein the digital avatar has configuration parameters defining character features of the digital avatar, and the state data further includes the configuration parameters.

20. A storage medium having computer executable instruction stored thereon, the computer executable instructions, when executed by one or more processors, enabling the one or more processors to, individually or collectively, implement a state acquisition module, a computer-simulated digital avatar, an agent embedded in the digital avatar, wherein:
the state acquisition module is configured to obtain current state data, the state data including user information of a target user, scenario information of a current scenario, and history information of an interaction between the target user and the digital avatar;
the agent in the digital avatar is configured to map the current state data to a target action in a candidate action set based on a current policy obtained through reinforcement learning, a candidate action in the candidate action set corresponding to a to-be-recommended content category, and the target action corresponding to a target content category; and
the digital avatar is configured to perform a target interaction with the target user, wherein the target interaction is used to recommend the target content category.
